(19) United States
(12) Patent Application Publication
(10) Pub. No.: US 2014/0347247 A1
(43) Pub. Date: Nov. 27, 2014

(54) ANTENNA DEVICE FOR ELECTRONIC DEVICE

(71) Applicant: Samsung Electronics Co., Ltd., Gyeonggi-do (KR)

(72) Inventors: Sung-Koo PARK, Gyeonggi-do (KR); Gyu-Sub Kim, Gyeonggi-do (KR); Soon-Ho Hwang, Seoul (KR); Joon-Ho Byun, Gyeonggi-do (KR); Kyung-Jae Lee, Seoul (KR)

(73) Assignee: Samsung Electronics Co., Ltd., Gyeonggi-do (KR)

(21) Appl. No.: 14/103,519

(22) Filed: Dec. 11, 2013

(30) Foreign Application Priority Data
May 27, 2013 (KR) 10-2013-0059761

(51) Int. Cl. H01Q 21/00

(52) U.S. Cl. CPC H01Q 21/0075
USPC 343/893

(57) ABSTRACT

An antenna device is provided for an electronic device. The antenna device includes a first radiation element and a second radiation element spaced apart from each other. The antenna device also includes a first feeding unit and a second feeding unit for feeding electricity to the first radiation element and the second radiation element, respectively. The antenna device further includes a first feeding port for connecting the first radiation element to the first feeding unit, and a second feeding port for connecting the second radiation element to the second feeding unit. The first feeding port and the second feeding port form electric/magnetic field coupling (E/H coupling) having a phase that differs from that of E/H coupling between the first radiation element and the second radiation element.

### PRIORITY

This application claims priority under 35 U.S.C. §119(a) to Korean Patent Application Serial No. 10-2013-0059761, which was filed in the Korean Intellectual Property Office on May 27, 2013, the entire disclosure of which is incorporated herein by reference.

### BACKGROUND OF THE INVENTION

1. Field of the Invention

The present invention relates generally to an electronic device, and more particularly, to an antenna device that enables wireless communication of an electronic device.

2. Description of the Related Art

An electronic device refers to a device that performs a particular function, for example, outputs stored information as audio or video, according to an embedded program. The electronic device may be embodied as an electronic appliance, an electronic note, a portable multimedia player, a mobile communication terminal, a tablet Personal Computer (PC), a video/audio device, a desktop/laptop computer, a vehicle navigation system, or the like. Various functions are able to be mounted on a single mobile communication terminal. For example, a mobile communication terminal includes a communication function as well as an entertainment function such as a game, a multimedia function for playback of music/video, communication and security functions for mobile banking, and a function for schedule management or an electronic wallet.

The size of a display device in a portable device has also increased, and various functions have been integrated into a single electronic device such as, for example, a mobile communication terminal.

For some electronic devices, for example, for a mobile communication terminal, an antenna device for performing wireless communication is provided. An antenna device capable of performing ultra-high-speed and high-volume communication is required to transmit and receive a high-quality and high-volume multimedia file. For ultra-high-speed and high-volume communication, a Multi-Input Multi-Output (MIMO) type antenna may be used. The MIMO antenna device simultaneously transmits different data through several paths, for example, multiple antennas, such that transmission and reception may be performed at high speeds without increasing a bandwidth of a system.

When the MIMO antenna device is configured, impedance matching and isolation between antennas, more specifically, radiation elements need to be secured for high radiation efficiency. In the MIMO antenna device, isolation between radiation elements may be secured by sufficiently isolating the radiation elements. However, in a portable electronic device, an internal space is small, and a sufficient distance between the radiation elements is difficult to secure. As a result, in a device having a small space in which the radiation elements may be mounted, an electric isolation structure such as a band pass filter, a circuit device like a lumped element, or an isolation pattern may be provided.

Even if isolation is secured through an electric or physical isolation structure, a space for such a separate electric or physical isolation structure is also required. For this reason, such a structure is not suitable to implement the MIMO antenna device in a miniaturized electronic device. Hence, the MIMO antenna device is suitable to perform ultra-high-speed and high-volume wireless communication, but its application to a miniaturized electronic device is limited.

### SUMMARY OF THE INVENTION

The present invention has been made to address at least the above problems and/or disadvantages and to provide at least the advantages described below. Accordingly, an aspect of the present invention provides an antenna device that operates in a MIMO manner and facilitates miniaturization.

Another aspect of the present invention provides an antenna device that suppresses interference between radiation elements, thus being able to be mounted on a miniaturized electronic device such as, for example, a mobile communication terminal.

According to an aspect of the present invention, an antenna device is provided for an electronic device. The antenna device includes a first radiation element and a second radiation element spaced apart from each other. The antenna device also includes a first feeding unit and a second feeding unit for feeding electricity to the first radiation element and the second radiation element, respectively. The antenna device further includes a first feeding port for connecting the first radiation element to the first feeding unit, and a second feeding port for connecting the second radiation element to the second feeding unit. The first feeding port and the second feeding port form electric/magnetic field coupling (E/H coupling) having a phase that differs from that of E/H coupling between the first radiation element and the second radiation element.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a block diagram illustrating an antenna device, according to an embodiment of the present invention;

FIG. 2 is a block diagram illustrating an antenna device, according to another embodiment of the present invention;

FIG. 3 is a diagram illustrating a perspective view of an antenna device, according to an embodiment of the present invention;

FIG. 4 is a graph showing radiation characteristics of an antenna device illustrated in FIG. 3, according to an embodiment of the present invention;

FIGS. 5 and 6 are graphs showing radiation characteristics for different distances between feeding ports of an antenna device illustrated in FIG. 3, according to an embodiment of the present invention;

FIG. 7 is a diagram illustrating a perspective view of an antenna device implemented in another form, according to an embodiment of the present invention;

FIG. 8 is a graph showing radiation characteristics of an antenna device illustrated in FIG. 7, according to an embodiment of the present invention;

FIG. 9 is a block diagram illustrating an antenna device of a MIMO type, according to another embodiment of the present invention;

FIG. 10 is a block diagram illustrating an antenna device of a MIMO type, according to another embodiment of the present invention;

FIG. 11 is a diagram illustrating a perspective view of an antenna device, according to another embodiment of the present invention; and

FIG. 12 is a graph showing radiation characteristics of an antenna device illustrated in FIG. 11, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

Terms used herein are defined for functions in the present invention and may vary according to users, intentions of operators, or practice. Thus, the terms should be defined more clearly based on the entire contents of various embodiments of the present invention. Although ordinal numbers such as “first”, “second”, and so forth will be used in an embodiment of the present invention described below, they are merely intended to distinguish objects having the same name. Their order may be set arbitrarily, and the preceding description of an object may be applied to a next-order object.

An antenna device, according to an embodiment of the present invention, includes a plurality of radiation elements, a plurality of feeding units, and a plurality of feeding ports for connecting the radiation elements to the feeding units. Electric/magnetic field coupling (E/H coupling) may be formed between the feeding ports to offset E/H coupling formed between the radiation elements. Therefore, sufficient isolation may be secured between the radiation elements without forming a separate band pass filter or isolation pattern.

More specifically, when E/H coupling is formed between the feeding ports, if a phase difference of 180° is provided for E/H coupling formed between the radiation elements, sufficient isolation may be secured between the isolation elements. However, it is not necessary for E/H coupling between the feeding ports to have a phase difference of 180° with respect to E/H coupling between the radiation elements. For impedance matching and resonance frequency adjustment, a phase difference of E/H coupling between the feeding ports with respect to E/H coupling between the radiation elements may be adjusted.

When the antenna device is configured, each feeding unit is connected to a common ground portion and is also connected to an independent ground portion, and the radiation elements are short-circuited to the common ground portion or the independent ground portions.

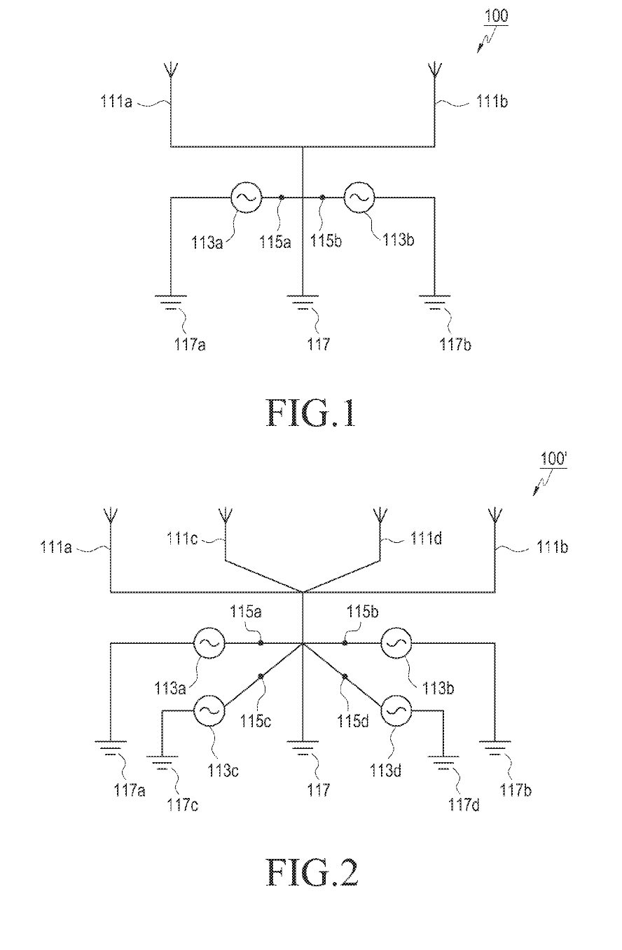

FIG. 1 is a block diagram illustrating an antenna device 100, according to an embodiment of the present invention. FIG. 2 is a block diagram illustrating an antenna device 100′, according to another embodiment of the present invention.

Referring to FIG. 1, the antenna device 100 includes first and second radiation elements 111a and 111b, first and second feeding units 113a and 113b. The antenna device also includes first and second feeing ports 115a and 115b for connecting the first and second radiation elements 111a and 111b to one of the first and second feeding units 113a and 113b, respectively. The first and second feeding ports 115a and 115b are positioned adjacent to each other to from E/H coupling.

The first and second radiation elements 111a and 111b each may be embodied as a whip antenna, a loop antenna, a meanderline antenna, a Planar-type Inverted F Antenna (PIFA), a patch antenna, or a chip antenna. The first and second radiation elements 111a and 111b is configured with a radiation pattern printed on a Printed Circuit Board (PCB) or a radiation pattern formed or attached on a separate carrier coupled to the PCB. Through the first and second radiation elements 111a and 111b, the antenna device 100 wirelessly transmits or receives a high-frequency signal.

The first and second feeding units 113a and 113b are connected to one of the first and second radiation elements 111a and 111b to provide a high-frequency signal or to receive a signal received through the first and second radiation elements 111a and 111b. The first and second feeding units 113a and 113b are connected to the same ground portion, for example, a common ground portion 117 at the same time, and are connected to independent ground portions 117a and 117b. Specifically, the first feeding unit 113a is connected to the common ground portion 117 and the first ground portion 117a, and the second feeding unit 113b is connected to the common ground portion 117 and the second ground portion 117b.

The first and second radiation elements 111a and 111b are short-circuited to the common ground portion 117, and are connected to one of the first and second feeding units 113a and 113b through one of the first and second feeding ports 115a and 115b. For example, the first feeding port 115a is provided between the first feeding unit 113a and the common ground portion 117, and the first radiation element 111a is connected to the first feeding unit 113a through the first feeding port 115a. The second feeding port 115b is provided between the second feeding unit 113b and the common ground portion 117, and the second radiation element 111b is connected to the second feeding unit 113b through the second feeding port 115b. Thus, the first radiation element 111a performs wireless transmission and reception with electricity fed from the first feeding unit 113a, and the second radiation element 111b performs wireless transmission and reception with electricity fed from the second feeding unit 113b, such that the antenna device 100 may operate in an MIMO manner.

When the antenna device 100 operates, electric-field (E) coupling or magnetic-field (H) coupling is formed between two different radiation elements. E/H coupling occurring between the radiation elements degrades radiation efficiency. On the other hand, the antenna device 100 forms E/H coupling between the first and second feeding ports 115a and 115b, thus attenuating E/H coupling between the first and second radiation elements 111a and 111b. For example, E/H coupling formed between the first and second feeding ports 115a and 115b has a phase difference with respect to E/H coupling formed between the first and second radiation elements 111a and 111b, thereby preventing degradation of radiation efficiency. In addition, as a distance between the first feeding port 115a and the second feeding port 115b is adjusted, S21 characteristics of a Scattering (S)-parameter change. By adjusting the distance between the first and second feeding port 115a and 115b, isolation between the first radiation element 111a and the second radiation element 111b may be secured and adjustment of a resonance frequency may be possible.

The antenna device 100′ illustrated in FIG. 2 has a structure that is similar to that of the antenna device illustrated in FIG. 1, except that four radiation elements, four feeding units, and four feeding ports are provided.

As illustrated in FIG. 2, in addition to the elements of the antenna device 100, the antenna device 100′ further includes third and fourth radiation elements 111c and 111d, third and fourth feeding units 113c and 113d corresponding to the third and fourth radiation elements 111c and 111d, and third and fourth feeding ports 115c and 115d. The third radiation element 111c is connected to the third feeding unit 113c and is short-circuited to the common ground portion 117, through the third feeding port 115c. The fourth radiation element 111d is connected to the fourth feeding unit 113d and is short-circuited to the common ground portion 117, through the fourth feeding port 115d.

In the antenna device 100 illustrated in FIG. 1 and the antenna device 100′ illustrated in FIG. 2, the first and second feeding ports 115a and 115b and the third and fourth feeding ports 115c and 115d are disposed adjacent to each other, thus forming E/H coupling. By adjusting distances between the first through fourth feeding ports 115a, 115b, 115c, and 115d, a phase of E/H coupling formed between the corresponding feeding ports may be adjusted. Thus, a phase difference between E/H coupling formed between the first and second feeding ports 115a and 115b and E/H coupling formed between the third and fourth feeding ports 115c and 115d is formed with respect to E/H coupling formed between the first and second radiation elements 111a and 111b and E/H coupling formed between the third and fourth radiation elements 111c and 111d, thereby attenuating E/H coupling between the first and second radiation elements 111a and 111b and E/H coupling formed between the third and fourth radiation elements 111c and 111d. Specifically, isolation between the first and second radiation elements 111a and 111b and isolation between the third and fourth radiation elements 111c and 111d may be secured. As described in greater detail below, the resonance frequencies of the antenna devices 100 and 100′ may be finely adjusted according to the distances between the first and second feeding ports 115a and 115b and the third and fourth feeding ports 115c and 115d.

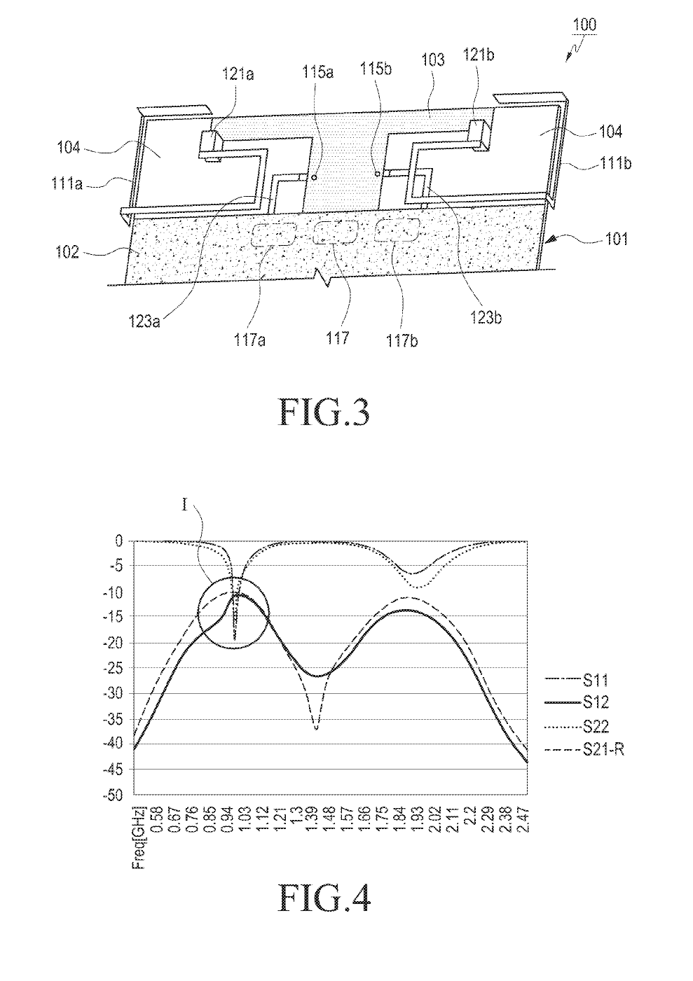

FIG. 3 is a diagram illustrating a perspective view of the antenna device 100 implemented according to an embodiment of the present invention.

Referring to FIG. 3, the antenna device 100 includes a PCB 101, which may be a flexible PCB or a dielectric board. The antenna device 100 includes a first conductive layer 102 and a second conductive layer 103 provided on the PCB 101. The first conductive layer 102 and the second conductive layer 103 both may be provided on a surface of the PCB 101, or may be provided on different surfaces (or layers) if the PCB 101 is a multi-layer board. The first conductive layer 102 and the second conductive layer 103 may provide grounding of various circuit devices or Integrated Circuit (IC) chips mounted on the PCB 101. The second conductive layer 103 extends from the first conductive layer 102 and may be formed in the shape of a ‘T’. If necessary, the shape of the second conductive layer 103 may vary. If the first and second conductive layers 102 and 103 are formed on the same surface or the same layer in the PCB 101, fill cut areas 104 may be provided in both sides of the second conductive layer 103. When the antenna device 100 is configured, the first and second conductive layers 102 and 103 provide the common ground portion 117 and the first and second ground portions 117a and 117b, and provide ground lines or feeding lines connected to the first and second feeding elements 111a and 111b or the first and second feeding ports 115a and 115b. The second conductive layer 103 may partially operate as a radiation element of the antenna device 100.

As illustrated in FIG. 3, connection members 121a and 121b are provided in end portions of both sides of the second conductive layer 103. The first and second radiation elements 111a and 111b of the antenna device 100 may be connected to the second conductive layer 103 through one of the connection members 121a and 121b, respectively. The connection members 121a and 121b may be embodied as c-clips. The first radiation elements 111a and 111b may be manufactured by processing a thin plate of a conductive metallic material, for example, a copper thin plate, or may be formed by depositing a metallic layer on the surface of a carrier and processing the metallic layer. The first and second radiation elements 111a and 111b may also be formed by using a flexible PCB.

The first and second feeding ports 115a and 115b are provided on the second conductive layer 103. If the first and second feeding ports 115a and 115b are provided on the second conductive layer 103, the second conductive layer 103 defined by the first conductive layer 102 and the first and second feeding ports 115a and 115b may be used as a ground line for connecting the first and second feeding ports 115a and 115b to the first conductive layer 102. Hence, the first conductive layer 102 may at least partially provide the common ground portion 117 that is connected to the first and second feeding ports 115a and 115b. Moreover, the first and second radiation elements 111a and 111b are connected to the first and second feeding ports 115a and 115b through the second conductive layer 103, respectively, and are short-circuited to the common ground portion 117.

The antenna device 100 may include separate ground lines 123a and 123b formed to traverse the fill cut areas 104. The ground lines 123a and 123b may provide independent paths for connecting the first and second feeding ports 115a and 115b to the first conductive layer 102, respectively. Thus, the first and second feeding ports 115a and 115b may be connected to the first conductive layer independently of each other, and the first conductive layer 102 may at least partially provide the first and second ground portions 117a and 117b. The common ground portion 117 and the first and second ground portions 117a and 117b are illustrated as particular regions in FIG. 3, but the embodiments of the present invention are not limited thereto.

After the antenna device 100, according to an embodiment of the present invention, is implemented as illustrated in FIG. 3, the radiation characteristics of the antenna device 100 are measured and measurement results are as shown in FIGS. 4 through 6. The graphs illustrated in FIGS. 4 through 6 show measurement results of an S-parameter of the antenna device 100 for different widths of the second conductive layer 103, more specifically, different intervals between the first feeding port 115a and the second feeding port 115b in the antenna device 100 illustrated in FIG. 3.

The S-parameter is a ratio of an output voltage to an input voltage with respect to frequency. S11 is a ratio of a voltage output from Port 1 to a voltage input to Port 1. Specifically, S11 indicates a ratio of an output voltage to an input voltage measured for the same port, and means a reflection value. Resonance frequency characteristics may be derived from S11.

S21 is a ratio between the voltage input to Port 1 and a voltage output from Port 2. Specifically, S21 indicates a ratio of the voltage output from Port 2 to the voltage input to Port 1, and means a transmission value. The characteristics of isolation between an input port and an output port may be derived from S21.

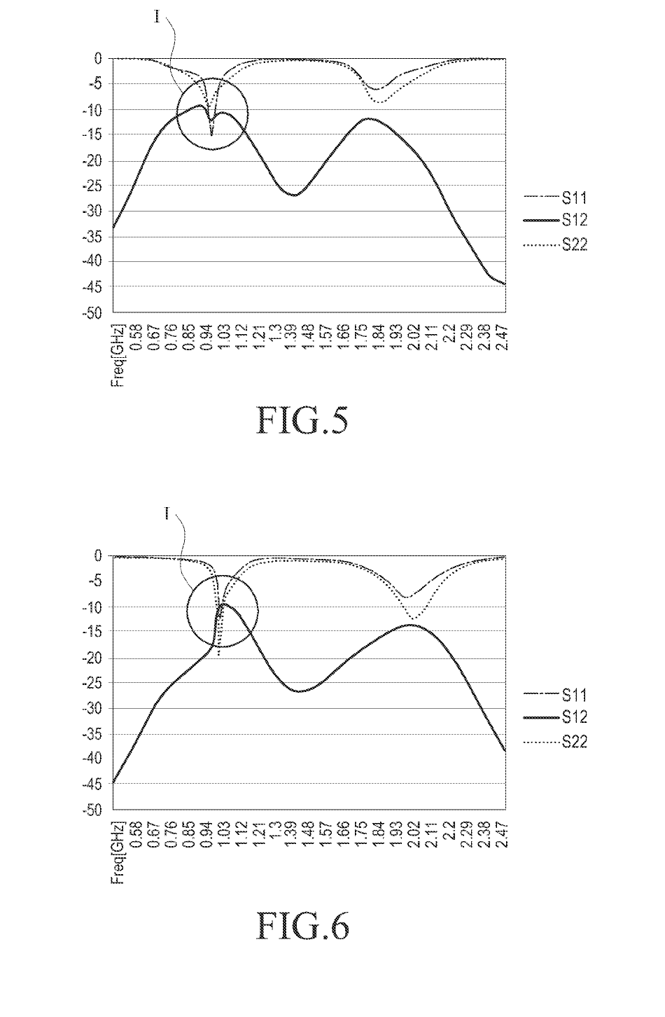

The antenna device 100 is provided on the PCB 101 having a width of 60 mm in the state illustrated in FIG. 3, in which the length of the fill cut area 104 is 15 mm, and the antenna device 100 is designed to form a resonance frequency at about 1 GHz. The graph illustrated in FIG. 4 shows an S-parameter of the antenna device 100, which is designed and manufactured to have an interval of 11 mm between the first feeding port 115a and the second feeding port 115b. The graph illustrated in FIG. 5 shows an S-parameter of the antenna device 100, which is designed and manufactured to have an interval of 7 mm between the first feeding port 115a and the second feeding port 115b. The graph illustrated in FIG. 6 shows an S-parameter of the antenna device 100, which is designed and manufactured to have an interval of 15 mm between the first feeding port 115a and the second feeding port 115b. E/H coupling is formed between the first feeding port 115a and the second feeding port 115b when an interval therebetween is less than 1/10 of a resonance frequency wavelength, more preferably, 1/20 of the resonance frequency wavelength. E/H coupling is formed between the first feeding port 115a and the second feeding port 115b when an interval therebetween is less than 15 mm. E/H coupling between the first feeding port 115a and the second feeding port 115b may have a phase difference with respect to E/H coupling between the first radiation element 111a and the second radiation element 111b. By using the phase difference, E/H coupling between the first radiation element 111a and the second radiation element 111b may be offset. For example, if E/H coupling between the first feeding port 115a and the second feeding port 115b has a phase difference of 180° with respect to E/H coupling between the first radiation element 111a and the second radiation element 111b, E/H coupling between the first radiation element 111a and the second radiation element 111b may be substantially completely offset. Thus, even if the first radiation element 111a and the second radiation element 111b are disposed adjacent to each other, sufficient isolation may be secured by offsetting E/H coupling between the first radiation element 111a and the second radiation element 111b.

In FIG. 4, ‘S21_R’ indicates S21 when the first feeding port 115a and the second feeding port 115b are disposed not to form E/H coupling. As described above, when an MIMO-type antenna device is configured, to secure isolation, a distance between radiation elements needs to be sufficiently secured. When a sufficient distance is secured between radiation elements, more specifically, between feeding ports connected to the radiation elements, the S21 parameter shows a gentle curve without a large curvature change, as indicated by S21_R of FIG. 4.

As shown in the graphs illustrated in FIGS. 4 through 6, even when the first feeding port 115a and the second feeding port 115b are disposed adjacent to each other with an interval of 15 mm or less therebetween, the S21 parameter of the antenna device 100 shows good performance of less than −10 dB in a resonance frequency band I. Thus, even if radiation elements are disposed adjacent to each other in a small space like in a mobile communication terminal, an MIMO-type antenna device may be configured. Additionally, a resonance frequency moves to a low frequency as a distance between the first feeding port 115a and the second feeding port 115b decreases. As the distance increases, the resonance frequency moves to a high frequency. Taking into account the change of the S21 parameter, a resonance frequency may be adjusted or impedance matching may be implemented by adjusting the distance between the first feeding port 115a and the second feeding port 115b while forming E/H coupling between the first feeding port 115a and the second feeding port 115b.

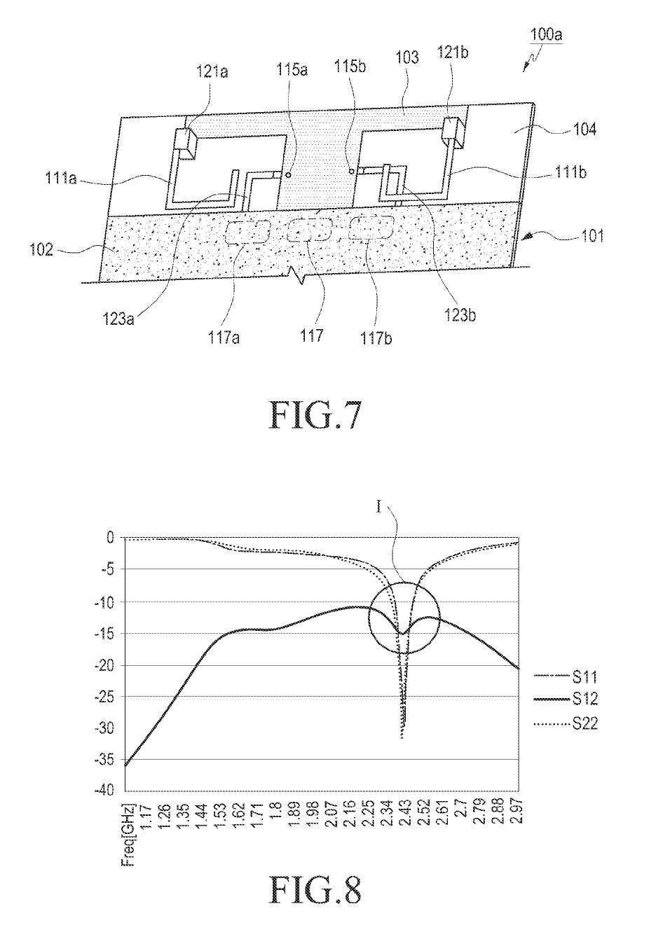

FIG. 7 is a diagram illustrating a perspective view of an antenna device 100a implemented in another form, according to an embodiment of the present invention. FIG. 8 is a graph showing results of measurement of the radiation characteristics, for example, an S-parameter, of the antenna device 100a illustrated in FIG. 7, according to an embodiment of the present invention. The antenna device 100a illustrated in FIG. 7 employs the structure of the antenna device 100 illustrated in FIG. 3, and is configured as an antenna device for short-range wireless communication such as, for example, Bluetooth or WiFi, in which the S21 parameter is maintained at −10 dB or less in a resonance frequency band of about 2.4 GHz. The antenna device 100a in FIG. 7 differs in shape from the antenna device 100 in FIG. 3, e.g. an electrical length of the first and second radiation elements 111a and 111b. Therefore, the resonance frequency of the antenna device 100a in FIG. 7 differs from that of the antenna device 100 in FIG. 3 as show in FIGS. 4-6 and FIG. 8.

As such, the antenna devices 100 and 100a, according to an embodiment of the present invention, may offset E/H coupling formed between radiation elements by forming E/H coupling between the first feeding port 115a and the second feeding port 115b. Thus, when an MIMO-type antenna device is configured, sufficient isolation may be secured even if the radiation elements are disposed in adjacent to each other. Specifically, E/H coupling formed between the radiation elements may be offset by forming E/H coupling between the feeding ports. Hence, an MIMO-type antenna device having stable radiation characteristics may be provided to an electronic device having a small mounting space like a mobile communication terminal.

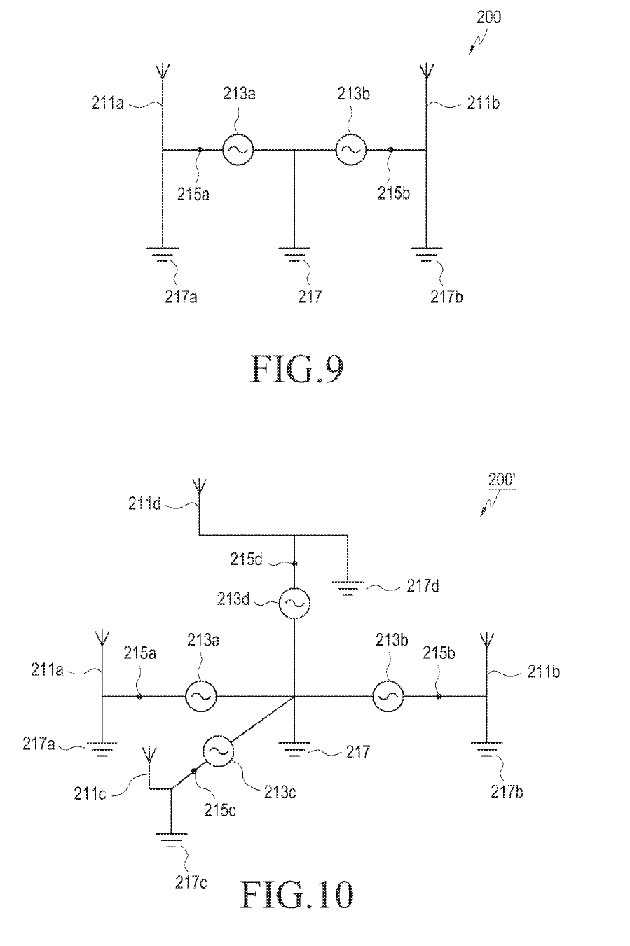

FIG. 9 is a block diagram illustrating an antenna device 200 of a MIMO type, according to another embodiment of the present invention. FIG. 10 is a block diagram of an antenna device 200′ of a MIMO type, according to another embodiment of the present invention.

Referring to FIG. 9, the antenna device 200 includes first and second radiation elements 211a and 211b, first and second feeding units 213a and 213b, and first and second feeding ports 215a and 215b for connecting the first radiation element 211a and the second radiation element 211b to one of the first feeding unit 213a and the second feeding unit 213b. The first feeding port 215a and the second feeding port 215b are positioned adjacent to each other to form E/H coupling.

The first radiation element 211a and the second radiation element 211b may each be embodied as a whip antenna, a loop antenna, a meanderline antenna, a PIFA, a patch antenna, or a chip antenna. The first radiation element 211a and the second radiation element 211b may include a radiation pattern printed on a PCB and a radiation pattern formed or attached on a separate carrier coupled to the PCB. The antenna device 200 may wirelessly transmit or receive a high-frequency signal through the first radiation element 211a and the second radiation element 217b.

The first feeding unit 213a and the second feeding unit 213b are connected to one of the first radiation element 211a and the second radiation element 211b, respectively, to provide a high-frequency signal or be provided with a signal received through the first radiation element 211a and the second radiation element 211b. The first feeding unit 213a and the second feeding unit 213b are connected to the same ground portion, for example, to the common ground portion 217, at the same time, and are connected to independent ground portions 217a and 217b, respectively. Specifically, the first feeding portion 213a is connected to the common ground portion 217 and the first ground portion 217a, and the second feeding portion 213b is connected to the common ground portion 217 and the second ground portion 217b.

The first radiation element 211a is short-circuited to the first ground portion 217a and is connected to the first feeding unit 213a through the first feeding port 215a. Thus, the first radiation element 211a is fed with electricity from the first feeding unit 213a to perform wireless transmission and reception, and the second radiation element 211b is fed with electricity from the second feeding unit 213b to perform wireless transmission and reception, such that the antenna device 200 operates in an MIMO manner.

In the antenna device 200, the first feeding port 215a and the second feeding port 215b are disposed adjacent to each other to form E/H coupling, such that E/H coupling between the first radiation element 211a and the second radiation element 211b is offset. For example, E/H coupling formed between the first feeding port 215a and the second feeding port 215b has a phase difference with respect to E/H coupling formed between the first radiation element 211a and the second radiation element 211b, thereby preventing degradation of radiation efficiency due to E/H coupling between radiation elements. As a distance between the first feeding port 215a and the second feeding port 215b is adjusted, S21 characteristics of an S-parameter change and by using the change, isolation between the first radiation element 211a and the second radiation element 211b may be secured and a resonance frequency may be adjusted.

An antenna device 200′ illustrated in FIG. 10 has a structure that is similar to the antenna device 200 illustrated in FIG. 9, and includes four radiation elements, four feeding units, and four feeding ports.

As illustrated in FIG. 10, in addition to the elements of the antenna device 200, the antenna device 200′ further includes third and fourth radiation elements 211c and 211d, third and fourth feeding units 213c and 213d corresponding to the third and fourth radiation elements 211c and 211d, and third and fourth feeding ports 215c and 215d. The third radiation element 211c is connected to the third feeding unit 213c through the third feeding port 215c and is short-circuited to a third ground portion 217c. The fourth radiation element 211d is connected to the forth feeding unit 213d through the fourth feeding port 215d and is short-circuited to a fourth ground portion 217d.

In the antenna device 200 illustrated in FIG. 9 and the antenna device 200′ illustrated in FIG. 10, the first and second feeding ports 215a and 215b and the third and fourth feeding ports 215c and 215d are disposed adjacent to each other, thus forming E/H coupling. By adjusting distances between the first through fourth feeding ports 215a, 215b, 215c, and 215d, a phase of E/H coupling formed between the corresponding feeding ports may be adjusted. Thus, a phase difference between E/H coupling formed between the first and second feeding ports 215a and 215b and E/H coupling formed between the third and fourth feeding ports 215c and 215d is formed with respect to E/H coupling formed between the first and second radiation elements 211a and 211b and E/H coupling formed between the third and fourth radiation elements 211c and 211d. Thus E/H coupling between the first and second radiation elements 211a and 211b and E/H coupling formed between the third and fourth radiation elements 211c and 211d is attenuated. Specifically, isolation between the first and second radiation elements 111a and 111b and isolation between the third and fourth radiation elements 211c and 211d may be secured. The resonance frequencies of the antenna devices 200 and 200′ may be adjusted or impedance-matched according to the distances between the first and second feeding ports 215a and 215b and the third and fourth feeding ports 215c and 215d.

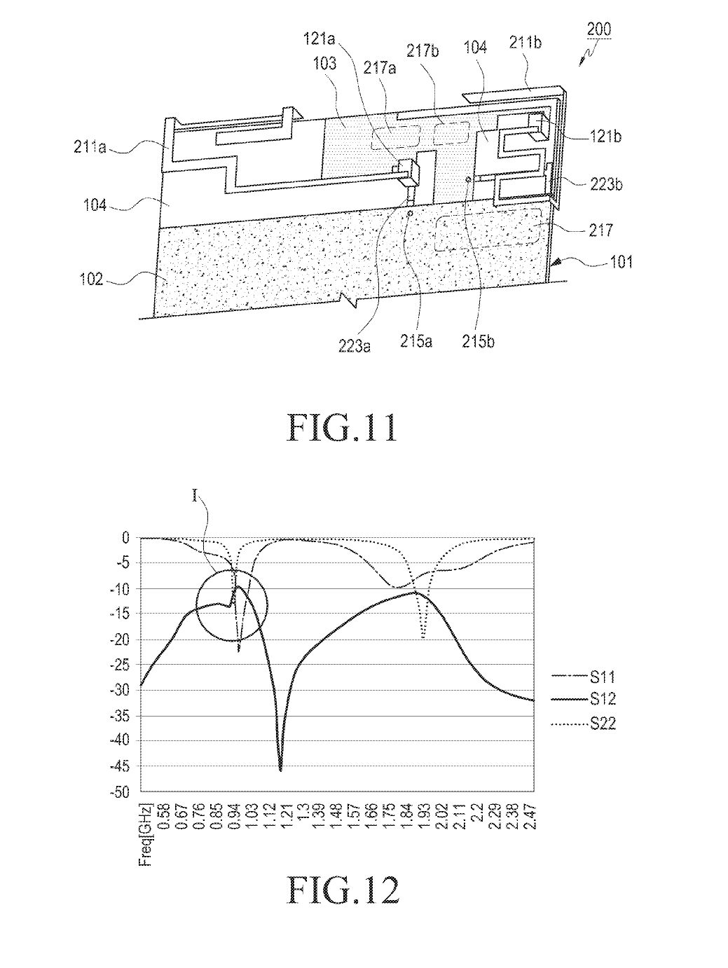

FIG. 11 is a diagram illustrating perspective view of the antenna device 200, according to another embodiment of the present invention. FIG. 12 is a graph showing the radiation characteristics of the antenna device 200 illustrated in FIG. 11, according to an embodiment of the present invention. When the antenna device 200 is implemented, the PCB 101 may be similar to that illustrated in FIG. 3 in spite of a small difference in size and shape.

Referring to FIG. 11, the antenna device 200 includes the PCB 101, which may be embodied as a flexible PCB or a dielectric board. The antenna device 200 may include the first conductive layer 102 and the second conductive layer 103 provided on the PCB 101. The first conductive layer 102 and the second conductive layer 103 may be simultaneously provided on a surface of the PCB 101 or on different surfaces (layers) if the PCB 101 is a multi-layer board. The first conductive layer 102 and the second conductive layer 103 may provide grounding of various circuit devices or integrated chips mounted on the PCB 101. The second conductive layer 103 extends from the first conductive layer 101 and is formed in the shape of a ‘T’. However, in the antenna device 200 illustrated in FIG. 11, the second conductive layer 103 may have a modified ‘T’ shape. If the first conductive layer 102 and the second conductive layer 103 are formed on the same surface or the same layer on the PCB 101, the fill cut areas 104 may be provided on both sides of the second conductive layer 103. When the antenna device 200 is configured, the first conductive layer 102 and the second conductive layer 103 may provide the common ground portion 217 and the first and second ground portions 217a and 217b. The first conductive layer 102 and the second conductive layer 103 may provide ground lines or feeding lines connected to the first and second radiation elements 211a and 211b or the first and second feeding ports 215a and 215b. The second conductive layer 103 partially operates as a radiation element of the antenna device 200.

The first and second radiation elements 211a and 211b may be manufactured by processing a thin plate of a conductive metallic material, for example a copper thin plate, or may be formed by depositing a metallic layer on the surface of a carrier and processing the metallic layer. The first and second radiation elements 211a and 211b may also be formed by using a flexible PCB. In the structure of the antenna device 200 illustrated in FIG. 11, the first radiation element 211a is a radiation element that supports an LTE Penta-band, and the second radiation element 211b may be used as an LTE secondary radiation element.

The first feeding port 215a is provided on the first conductive layer 102, and the second feeding port 215b is provided on the second conductive layer 103. The first feeding port 215a is connected to the second conductive layer 103 through a separate connection line 223a. The second feeding port 215b is connected to the first conductive layer 102 through a separate ground line 223b. The connection line 223a and the ground line 223b may extend from the both sides of the second conductive layer 103 to traverse the fill cut areas 104. Thus, the first conductive layer 102 at least partially provides the common ground portion 217 of the first feeding port 215a and the second feeding port 215b. The second conductive layer 103 provides the first ground portion 217a connected to the first feeding port 215a and the second ground portion 217b connected to the second feeding port 215b. The common ground portion 217 and the first and second ground portions 217a and 217b are illustrated as particular regions in FIG. 11, but the embodiments of the present invention are not limited thereto.

The first feeding port 215a is provided on the first conductive layer 102 and is connected to the common ground portion 217. As the first feeding port 215a is connected to the first ground portion 217a through the connection line 223a, the first feeding port 215a may be connected with the first radiation element 211a. The first radiation element 211a may be short-circuited to the first ground portion 217a through a separate connection member 121a and the connection line 223a. Likewise, the second feeding unit 213b is provided on the second conductive layer 103 and is connected to the common ground portion 217 through the ground line 223b. The second feeding unit 213b may also be connected to the second ground portion 217b through the second conductive layer 103 and to the second radiation element 211b through another connection member 121b. The second radiation element 211b may be short-circuited to the second ground portion 217b. The connection members 121a and 121b may be mounted on the connection line 223a and the second conductive layer 103. The positions of the connection members 121a and 121b may be varied.

By disposing the first and second feeding ports 215a and 215b adjacent to each other on the first conductive layer 102 and the second conductive layer 103, respectively, E/H coupling may be formed between the first feeding port 215a and the second feeding port 215b. E/H coupling formed between the first feeding port 215a and the second feeding port 215b adjusts a distance therebetween, thus having a phase difference with respect to E/H coupling formed between the first radiation element 211a and the second radiation element 211b. Thus, E/H coupling formed between the first radiation element 211a and the second radiation element 211b may be offset by the phase difference of E/H coupling formed between the first feeding port 215a and the second feeding port 215b. For example, if E/H coupling formed between the first feeding port 215a and the second feeding port 215b has a phase difference of 180° with respect to E/H coupling formed between the first radiation element 211a and the second radiation element 211b, E/H coupling formed between the first radiation element 211a and the second radiation element 211b may be substantially completely offset.

Results of measurement of the radiation characteristics of the antenna device 200 illustrated in FIG. 11, for example, an S21 parameter, are shown in FIG. 12. In FIG. 12, with respect to a change of the S21 parameter, the S21 parameter is maintained at −10 dB or less in a frequency band of about 900 MHz, and shows a sharp change rather than a gentle curve. Referring to the change of the S21 parameter, it can be seen that by disposing the first feeding port 215a and the second feeding port 215b adjacent to each other, an MIMO antenna device may be configured and at the same time, resonance characteristics may be secured in a desired frequency band. Specifically, by disposing the first feeding port 215a and the second feeding port 215b adjacent to each other, E/H coupling between the first radiation element 211a and the second radiation element 211b is offset and stable resonance characteristics are secured, thus implementing an MIMO operation.

As is apparent from the foregoing description, the antenna device, according to embodiments of the present invention, may offset E/H coupling formed between radiation elements by forming E/H coupling between a plurality of feeding ports. The antenna device may secure isolation even when radiation elements are disposed adjacent to each other, thus providing miniaturization and securing stable radiation efficiency in an MIMO scheme. Moreover, to secure isolation between the radiation elements, the addition of an electric and physical isolation structure is not necessary, further miniaturizing the MIMO antenna device. Therefore, embodiments of the present invention facilitate installation of the MIMO antenna device in an electronic device such as, for example, a mobile communication terminal, an information device like a vehicle navigation system, a portable multimedia player, a tablet PC, a wireless sharing device, or the like while miniaturizing the electronic device.

While the invention has been shown and described with reference to certain embodiments thereof, it will be understood by those skilled in the art that various changes in form and detail may be made therein without departing from the spirit and scope of the invention as defined by the appended claims.

What is claimed is:

1. An antenna device for an electronic device, the antenna device comprising:
a first radiation element and a second radiation element spaced apart from each other;
a first feeding unit and a second feeding unit for feeding electricity to the first radiation element and the second radiation element, respectively;
a first feeding port for connecting the first radiation element to the first feeding unit; and
a second feeding port for connecting the second radiation element to the second feeding unit,
wherein the first feeding port and the second feeding port form electric/magnetic field coupling (E/H coupling) having a phase that differs from that of E/H coupling between the first radiation element and the second radiation element.

2. The antenna device of claim 1, further comprising:
a common ground portion connected to the first feeding unit and the second feeding unit;
a first ground portion connected to the first feeding unit; and
a second ground portion connected to the second feeding unit.

3. The antenna device of claim 2, wherein the first radiation element and the second radiation element are short-circuited to the common ground portion.

4. The antenna device of claim 3, further comprising:
a third feeding unit connected to the common ground portion and a third ground portion; and
a third radiation element connected to the third feeding unit through a third feeding port,
wherein the third radiation element is short-circuited to the common ground portion.

5. The antenna device of claim 3, further comprising:
a Printed Circuit Board (PCB);
a first conductive layer provided on the PCB; and
a second conductive layer that is provided on the PCB and extends from the first conductive layer,
wherein the common ground portion, the first ground portion, and the second ground portion are provided on the first conductive layer.

6. The antenna device of claim 5, wherein the first feeding port and the second feeding port are provided on the second conductive layer, and are connected to the first conductive layer through the second conductive layer.

7. The antenna device of claim 6, further comprising ground lines for connecting the first feeding port and the second feeding port to the first conductive layer.

8. The antenna device of claim 6, further comprising at least a pair of connection members provided on the second conductive layer,
wherein the first radiation element and the second radiation element are connected to the second conductive layer through one of the connection members, are connected to the first feeding port and the second feeding port through the second conductive layer, and are short-circuited to the common ground portion.

9. The antenna device of claim 2, wherein the first radiation element is short-circuited to the first ground portion, and the second radiation element is short-circuited to the second ground portion.

10. The antenna device of claim 9, further comprising:
a third feeing unit connected to the common ground portion and a third ground portion; and
a third radiation element connected to the third feeding unit through a third feeding port,
wherein the third radiation element is short-circuited to the third ground portion.

11. The antenna device of claim 9, further comprising:
a PCB;
a first conductive layer provided on the PCB; and
a second conductive layer that is provided on the PCB and extends from the first conductive layer,
wherein the common ground portion is provided on the first conductive layer, and the first ground portion and the second ground portion are provided on the second conductive layer.

12. The antenna device of claim 11, further comprising:
a connection line having a first end that is connected to the first conductive layer, and a second end connected to the second conductive layer; and
a connection member mounted on the connection line,
wherein one of the first feeding port and the second feeding port is connected to the connection member through the connection line on the first conductive layer.

13. The antenna device of claim 12, wherein one of the first radiation element and the second radiation element is connected to one of the first feeding port and the second feeding port through the connection member and is short-circuited to the second conductive layer.

14. The antenna device of claim 11, further comprising:
a ground line having a first end connected to the first conductive layer, and a second end connected to the second conductive layer; and
a connection member provided on the second conductive layer,
wherein one of the first feeding port and the second feeding port is provided on the second conductive layer, and one of the first feeding port and the second feeding port is connected to the first conductive layer through the ground line and is connected to the connection member through the second conductive layer.

15. The antenna device of claim 14, wherein one of the first radiation element and the second radiation element is connected to one of the first feeding port and the second feeding port through the connection member, and is short-circuited to the second conductive layer.

16. The antenna device of claim 1, wherein E/H coupling between the first feeding port and the second feeding port has a phase difference of 180° with respect to E/H coupling of the first radiation element and the second radiation element.

17. The antenna device of claim 1, wherein at least one of the first radiation element and the second radiation element is a radiation pattern formed on a PCB.

18. The antenna device of claim 17, wherein the PCB is a dielectric board.
